(19) United States
(12) Patent Application Publication
(10) Pub. No.: US 2002/0017171 A1
(43) Pub. Date: Feb. 14, 2002

(54) Oil filter wrench

(76) Inventor: Hsueh Chin Chang, Taichung City (TW)

Correspondence Address: HSUEH CHIN CHANG, P.O.BOX 63-150, Taichung City, TW

(21) Appl. No.: 09/805,764

(22) Filed: Mar. 12, 2001

(30) Foreign Application Priority Data
Aug. 9, 2000 (TW) 89213952

(51) Int. Cl. B25B 13/22

(52) U.S. Cl. 81/133

(57) ABSTRACT

The present invention discloses an oil filter wrench comprising a wrench body having an axial hollow space at the center of a surface along one end of its axis, and each of the both surfaces of the axial hollow space has a sliding groove parallel to each other, and a driving device being disposed at the center of the surface along the other end of the axis for the mounting of a cylindrical driver; a pair of clipping members being pivotally coupled to two sliding grooves of the wrench body by means of sliding displacement, and its thickness corresponds with the parallel position and has serrations on them. A tong is disposed on each end of the corresponding axes for interlocking with a circular edge of the oil filter; a serrated gear being disposed at the axial hollow space of the wrench body by means of the predetermined pivotal coupling, and a gear section being disposed at the external diameter of the surface along the axial direction for mutual coupling with a pair of serrations of the clipping member, and a ratchet section being disposed at the lower external diameter of the surface along the axial direction and one of its end is for pivotally coupling a ratchet claw with blocking function; an elastic component is single-directionally coupled to the axial hollow of the wrench body with blocking function in order to provide the resuming force for the axial rotation of the ratchet head. In the foregoing structure, the oil filter can be held and rotated quickly when the release of dynamic force by the return rotation of the ratcheted head to drive the pair of clipping members to displace in reverse direction.

### BACKGROUND OF THE INVENTION

1. Field of the Invention

The present invention relates to an automobile maintenance tool, and more particularly to an oil filter wrench that is easy to operate in a limited working space.

2. Description of the Related Art

In general, we need special tools to remove motor oil filter of a vehicle. As shown in FIG. 1, a traditional oil filter wrench has a pair of handle members 1a, 2a being pivotally coupled to each other at the appropriate position proximate to the users. The front part of the handle member 1a has a chain member 3a, and the other end latches into the dented groove 4a at the front part of the handle member 2a, thereby when removing the oil filter, the chain member 3a surrounds the external rim of the oil filter by using suitable chain size depending of the diameter of the oil filter. However, when using such tool, the chain member 3a and the handle member 1a keeps the chain straight, and force cannot be easily applied to such structure especially in a crowded-with-components space of the engine under the hood. It makes the disassembly difficult and wastes of energy. On the other hand, since each ring of the chain member 3a has a definite length, it is very limited in adjusting its length for the oil filters with different specifications, and not even to mention the fine-tuning. Therefore, it is obvious that the traditional oil filter wrench is not flexible enough to meet the user's requirement.

In summation of the above description, the inventor bases on years of his experience in this field to conduct research on a simple-to-use and convenient wrench to solve the problems and break through the bottlenecks of the traditional open wrench structure.

### SUMMARY OF THE INVENTION

The primary objective of the present invention is to provide an oil filter wrench that is able to operate easily and efficiently for different brands of oil filter. According to the present invention of an oil filter wrench capable of unscrewing oil filters of different sizes in a limited working space.

The oil filter wrench according to the present invention comprises a wrench body having an axial hollow space at the center of a surface along one end of its axis, and each of the both surfaces of the axial hollow space has a sliding groove parallel to each other, and a driving device being disposed at the center of the surface along the other end of the axis for the mounting of a cylindrical driver; a pair of clipping members being pivotally coupled to two sliding grooves of the wrench body by means of sliding displacement, and its thickness corresponds with the parallel position and has serrations on them. A tong is disposed on each end of the corresponding axes for interlocking with a circular edge of the oil filter; a serrated gear being disposed at the axial hollow space of the wrench body by means of the predetermined pivotal coupling, and a gear section being disposed at the external diameter of the surface along the axial direction for mutual coupling with a pair of serrations of the clipping member, and a ratchet section being disposed at the lower external diameter of the surface along the axial direction and one of its end is for pivotally coupling a ratchet claw with blocking function; an elastic component is single-directionally coupled to the axial hollow of the wrench body with blocking function in order to provide the resuming force for the axial rotation of the ratchet head. In the foregoing structure, the oil filter can be held and rotated quickly when the release of dynamic force by the return rotation of the ratcheted head to drive the pair of clipping members to displace in reverse direction.

To make it easier for our examiner to understand the objective of the invention, its structure, innovative features, and its performance, we use a preferred embodiment together with the attached drawings for the detailed description of the invention

### BRIEF DESCRIPTION OF THE DRAWINGS

Other objects, features, and advantages of the invention will become apparent from the following detailed description of the preferred but non-limiting embodiment. The description is made with reference to the accompanying drawings, in which:

FIG. 1 is a three-dimensional diagram of the traditional oil filter wrench.

FIG. 2 is a three-dimensional diagram showing the disassembled parts of a preferred embodiment of the present invention.

FIG. 3 is a planar schematic diagram of a preferred embodiment of the present invention.

FIG. 4 shows a transversal cross-section of a preferred embodiment of the present invention.

FIG. 5 shows a longitudinal cross-section of a preferred embodiment of the present invention.

FIG. 6 is a three-dimensional schematic diagram showing the application of preferred embodiment of the present invention.

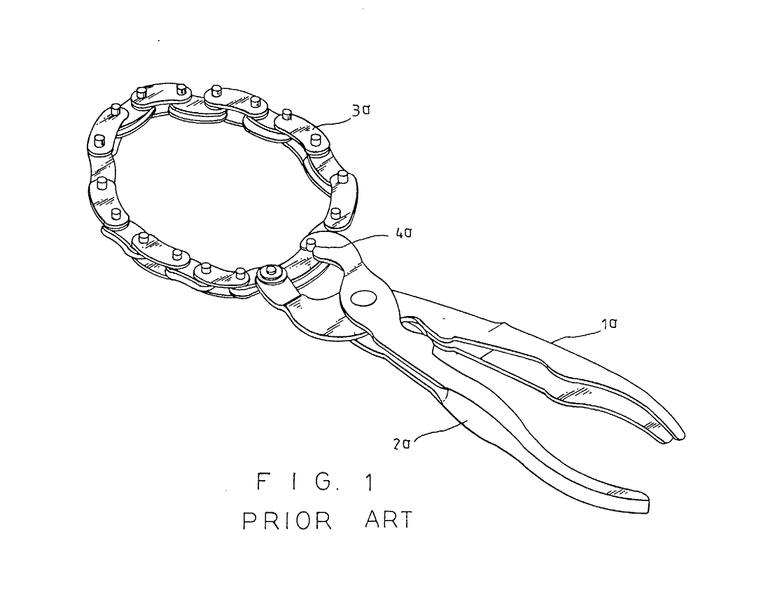

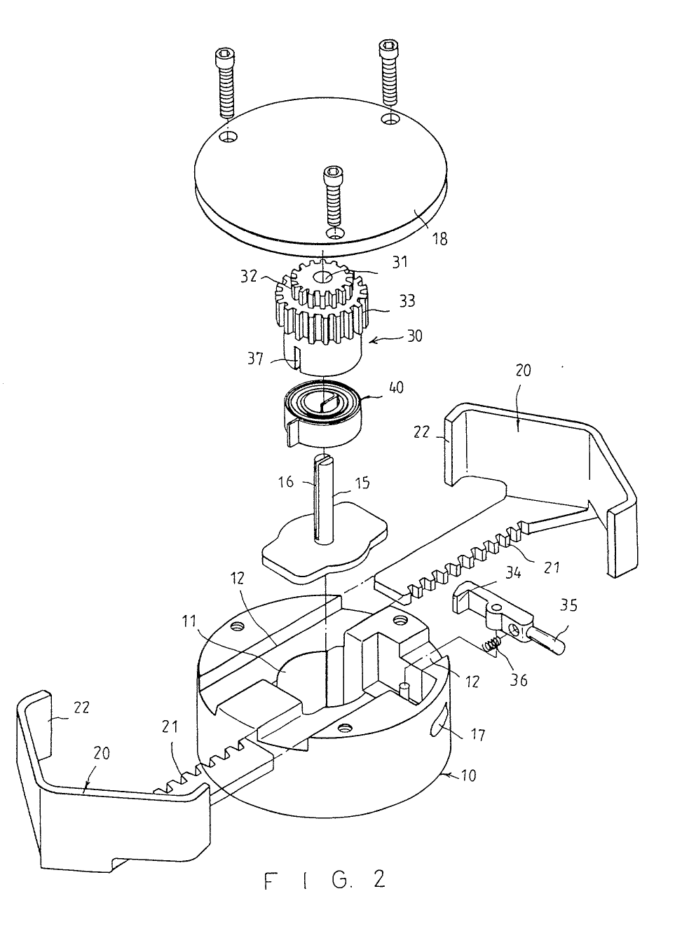

### DETAILED DESCRIPTION OF THE PREFERRED EMBODIMENTS

Please refer to Figures. The present invention is an oil filter wrench comprises a circular wrench body 10, a pair of clipping members, a ratcheted gear head 20, and an elastic member 40; wherein the circular wrench body 10 having an axial hollow 11 at the center of a surface along one end of its axis, and each of the both surfaces of the axial hollow space 11 has a sliding groove 12 parallel to each other, and a driving device 13 being disposed at the center of the surface along the other end of the axis for the mounting of a cylindrical driver 14; and the axial hollow 11 is coupled to an axial post 15. The axial post 15 has a positioning clipping groove 16, and the sidewall of the wrench body 10 has a penetrating hole 17, and a lid 18 to latch into the surface of the wrench body 10.

A pair of clipping members 20 being pivotally coupled to two sliding grooves 12 of the wrench body 10 by means of sliding displacement, and its thickness corresponds with the parallel position and has serrations 21 on them. A tong 22 is disposed on each end of the corresponding axes for interlocking with a circular edge of the oil filter.

A ratcheted gear head 30 passes through a hole 31 being coupled to the axial post 15 in the axial hole space 11 of the wrench body 10, and a gear section 32 is disposed on the external diameter of the surface along its axis for mutually coupled to a pair the serrations 21 of the clipping member 20. A ratchet section 33 being disposed at the lower external diameter of the surface along the axial direction and one of its end is for pivotally coupling a ratchet claw 34 with blocking function. The other end of the ratcheted claw 34 has a linking rod 35 that passes through the penetrating hole 17 on the periphery of the wrench body for the user to poke. The ratcheted claw 34 has an spring 36 on its side to push the ratcheted claw 34 to embed into the ratchet section 33, and the ratcheted section 33 has a clipping gap 37 on the lower sidewall.

One end of an elastic component 40 (such as a spiral spring) is single-directionally coupled to the axial post 11 of the position-clipping groove 16 in the axial hollow 11 of the wrench body 10, and the other end being coupled to a clipping gap 37 on the sidewall of the ratchet head 30 in order to provide the resuming force for the pivotal rotation of the ratcheted head 30.

When assembling the foregoing structure, place the axial post 15 inside the axial hollow 11 of the wrench body 10, and passes the elastic component (such as a spiral spring) 40 onto the axial post 15, and then sheathe the hole 31 on the ratchet head 30 into the axial post 15. Meanwhile, let one end of the elastic component 40 plug into the position-clipping groove 16 on the axial post 15, and fix the other end into the clipping gap 37 on the lower sidewall of the ratchet head 30. The periphery of the ratchet gear section 32 of the ratchet head 30 is embedded with the ratcheted claw 34. Then mount the two clipping members 20 on the sliding groove 12 of the wrench body 10. The serrations 21 on the clipping member 20 is embedded in the gear section 32 of the ratchet head 30. Finally latch the lid to the surface of the wrench body 10 and secure the structure by screws and combines the components together as a whole piece.

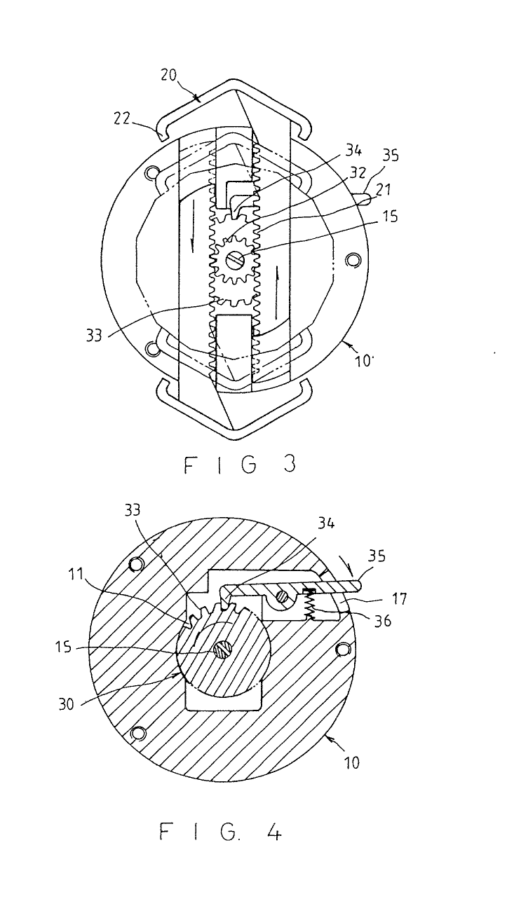

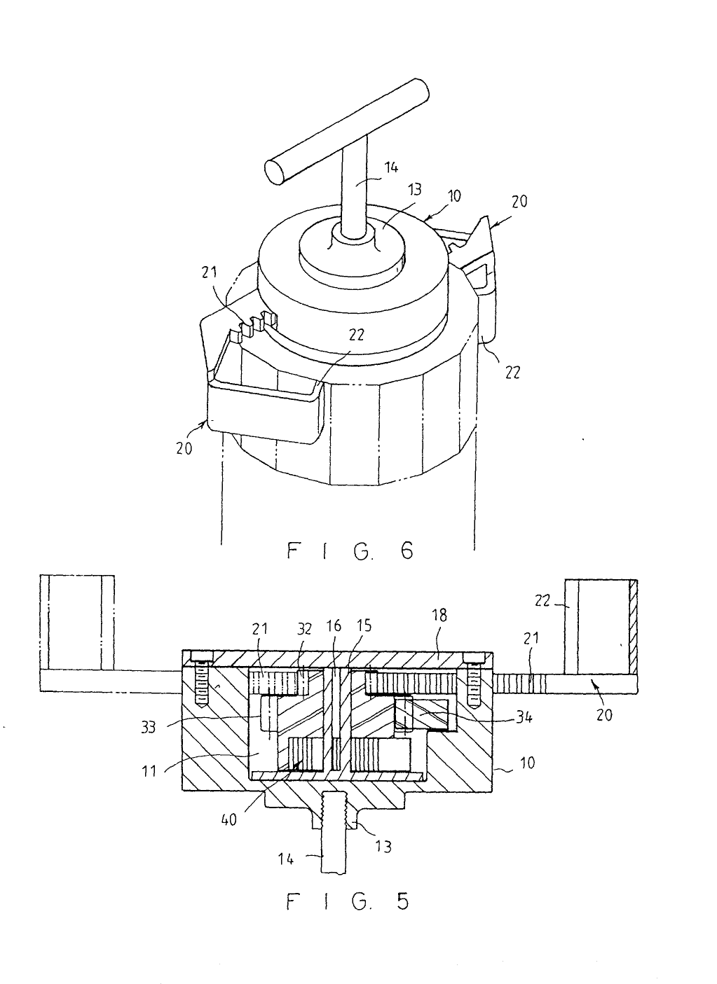

Please refer to FIG. 3 for the application of the oil filter wrench according to the present invention. When both hands expand the clipping members 20, the gear section 32 of the ratchet head 30 is carried to rotate in counter-clockwise direction. At that time, the ratchet section 33 at the lower portion of the ratchet head 30 also rotates in counter-clockwise direction as shown in FIG. 4. The ratcheted claw 34 on a lateral side of the ratcheted section 33 will single-directionally poke the ratcheted portion 33 due to the pressing force exerted by the spring 36 against the ratcheted claw 34. In addition, when the ratcheted head 30 rotates back in counter-clockwise direction, the elastic component 40 (a spring) will be compressed. When the clipping members 20 are extended in such a way that the distance between the tongs 22 is long enough to hold the periphery of the oil filter, poking the ratcheted claw 34 being disposed on the linking rod 35 outside the penetrating hole 17 of the wrench body 10 by hand will separate the ratcheted claw 34 from the ratchet section 33. Due to the ratchet section 33 losses its embedding function, the force exerted by the compressed spring 40 will rotate in a reverse direction such that the gear section 32 will rotate in clockwise direction accordingly. Meanwhile, the serrations 21 of the clipping members 20 coupled to it are pulled inward, thereby the periphery of the oil filter is clipped on both directions by the tongs 22 of the clipping members 20. As the wrench body 10 is rotated, the other surface of the cylindrical driver 14 is driven and rotated to mount or dismount the oil filter.

Compared with the prior art, the present invention has a first advantage that it fits all kinds of oil filters, mainly because of the assembled relation of the serrations 21 and the gear section 32 of the clipping members 20 to accomplish the adjustment of the distance between the tongs 22 with no restriction practically. It is obvious that the present invention has advantage over the traditional chain wrench, which is always limited by the length of the chain, and specifications of different oil filters. The second advantage of the present invention is that the oil filter wrench according to the present invention is easy-to-use, simple, and fast. Since the operation of clipping the oil filter is by extending the tongs by hand to let the clipping members 20 reach the external periphery of the oil filter, and poke the linking rod 35 to securely clip the oil, and the user can mount or dismount an oil filter very easily. The third advantage of the present invention is that the clipping member 20 for clipping the oil filter is disposed freely on a lateral surface of the wrench body 10, and the tongs clip the oil filter on both sides, and the other surface is available for a cylindrical driver of appropriate length to rotating the oil filter. During rotating, the cylindrical driver 14 can extend outside the engine chamber, so that the limited space under the hood will not affect the operation of mounting or dismounting an oil filter.

In summation of the above description, the present invention herein enhances the performance of the conventional wrench structure and further complies with the patent application requirements and is submitted to the Patent and Trademark Office for review and granting of the commensurate patent rights.

While the invention has been described by way of example and in terms of a preferred embodiment, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

What is claimed is:

1. An oil filter wrench, comprising:
a wrench body, having an axial hollow space at the center of a surface along one end of its axis, and each of the both surfaces of the axial hollow space has a sliding groove parallel to each other, and a driving device being disposed at the center of the surface along the other end of the axis for the mounting of a cylindrical driver;
a pair of clipping members being pivotally coupled to two sliding grooves of the wrench body by means of sliding displacement, and its thickness corresponds with the parallel position and has serrations on them, and a tong is disposed on each end of the corresponding axes for interlocking with a circular edge of the oil filter;
a ratcheted gear head being disposed at the axial hollow space of the wrench body by means of the predetermined pivotal coupling, and a gear section being disposed at the external diameter of the surface along the axial direction for mutual coupling with a pair of serrations of the clipping member, and a ratchet section being disposed at the lower external diameter of the surface along the axial direction and one of its end is for pivotally coupling a ratchet claw with blocking function; an elastic component is single-directionally coupled to the axial hollow of the wrench body with blocking function in order to provide the resuming force for the axial rotation of the ratchet head;
thereby in the foregoing structure, the oil filter can be held and rotated quickly when the release of dynamic force by the return rotation of the ratcheted head to drive the pair of clipping members to displace in reverse direction.

2. An oil filter wrench as claimed in claim 1, wherein has a chamber groove to pivotally accommodate said ratcheted claw at the appropriate position on the lateral side of the axial hollow of the wrench body, and an elastic member disposed on its side to act as a stopper; said ratcheted claw has a pressing end at its front end to top the ratchet section of the ratchet gear head in a single direction, and its end extends to pass through said groove chamber and exposes to the link rod section outside the wrench body such that the separation between the ratcheted claw and the ratchet gear section is controlled by rotating the oil filter wrench.
